(19) United States
(12) Patent Application Publication
(10) Pub. No.: US 2009/0256441 A1
(43) Pub. Date: Oct. 15, 2009

(54) Motor structure

(75) Inventors: Alex Horng, Kaohsiung City (TW); To-Nien San, Kaohsiung City (TW)

Correspondence Address: BACON & THOMAS, PLLC, 625 SLATERS LANE, FOURTH FLOOR, ALEXANDRIA, VA, 22314-1176, US

(73) Assignee: Sunonwealth Electric Machine Industry Co., Ltd., Kaohsiung City (TW)

(21) Appl. No.: 12/155,959

(22) Filed: Jun. 12, 2008

(30) Foreign Application Priority Data
Apr. 14, 2008 (TW) 097113452

(51) Int. Cl. H02K 5/16

(52) U.S. Cl. 310/90

(57) ABSTRACT

The present invention relates to a motor structure, which includes a base having a shaft tube centrally, in which a bottom portion of the shaft tube is sealed for placing a bearing therein, and at least a reference plane is provided on the outer periphery of the shaft tube; a rotor having a spindle disposed centrally therein for passing through the bearing and rotating therein; a stator module disposed on the outer periphery and positioned on the reference plane. Besides, an urging part is disposed on an inner periphery of the top insulation sleeve of the stator module to urge against the bearing so that the precise assembling position of the stator module can be definitely defined to prevent the bearing from getting loose due to high assembling position and to prevent the fracture of the urging part due to low assembling position.

### FIELD OF THE INVENTION

The present invention relates to a motor structure, and more particularly to a motor structure that focuses on the improvement of the assembly and positioning means of the stator module and the bearing to facilitate more convenient and faster assembly of the stator module and the bearing and to provide a better positioning effect.

### BACKGROUND OF THE INVENTION

As shown in FIG. 1, the conventional motor structure includes a base 10, a rotor 20 and a stator module 30, in which the base 10 has a hollow shaft tube 11 centrally and the shaft tube 11 can receive a bearing 12, a snap ring 13, an abrasive plate 14 and an oil seal cover 15, the stator module 30 is mounted on the outer wall of the shaft tube 11, and the spindle 21 located centrally in the rotor 20 passes through the bore of the bearing 12 and rotates therein and the rotor 20 and the stator module 30 are disposed in a corresponding manner to constitute a motor structure.

In such conventional motor structure, its stator module 30 is fixed on the outer wall of the shaft tube 11 with a tight fit. The stator module 30 is formed by sandwiching a plurality of silicon steel sheets 33 with a top insulation sleeve 31 and a bottom insulation sleeve 32; between the top and bottom insulation sleeves 31, 32 is wound around with a metal winding (not shown in FIG. 1); the silicon steel sheets 33 are tightly fastened on the outer wall of the shaft tube 11.

The top insulation sleeve 31 is used to sleeve around the shaft tube 11 and has an urging part 311 on its inner wall which can be designed as a plurality of urging pieces having a form of convex ring so that the urging part 311 can block the bearing 12 to prevent the bearing from getting loose.

Whereas, while assembling the stator module 30 of the conventional motor structure, where the stator is sleeved on the shaft tube 11 is merely a rough position and not a precise assembling position of the stator module 30 that is definitely defined. Hence, the following disadvantages arise therefrom accordingly.

1. As shown in FIG. 1, while the position of mounting the stator module 30 is too high, it is prone to noise generation: For sake of facilitating the assembly of the bearing 12 and preventing the shaft tube 11 from being squeezed and deformed, loose fit with tiny clearance is extensively present between the bearing 12 and the inner wall of the shaft tube 11. Therefore, when the assembling position of the stator module 30 is too high, although the bearing 12 won't come off, the urging part 311 of the top insulation sleeve 31 won't be able to urge the bearing against its predetermined position so as to leave space between the bearing 12 and the shaft tube that makes the bearing becomes jumpy therein. When the motor structure is operating, vibration noise will be caused out of the resonance of the bearing 12, the snap ring 13 and so on.

2. As shown in FIG. 2, when the assembling position of the stator module 30 is too low, the urging part 311 is prone to fracture: When the urging part 311 is urged against the bearing 12, it is used to urge against the bearing 12 with the adequate elastic deformation thereof to prevent the bearing 12 from getting loose or coming off. However, when the assembling position of the stator module 30 is too low, the urging part 311 will be forced to have larger deformation possibly in excess of its maximal allowable deformation that will cause fracture.

### SUMMARY OF THE INVENTION

In view of the foregoing concern, the present invention thus provides a motor structure whose object is to improve the assembling and positioning means of the stator module and the bearing so that the stator module and the bearing can be more conveniently and promptly assembled and provide better positioning effect.

The motor structure of the present invention includes a base having a hollow shaft tube centrally, in which a bottom portion of the shaft tube is sealed for placing a bearing therein, and at least a reference plane is provided on the outer periphery of the shaft tube; a rotor having a spindle centrally for passing through the bore of the bearing and rotating therein; a stator module disposed on the outer periphery of the shaft tube and formed by sandwiching a plurality of silicon steel plates with a top insulation sleeve and a bottom insulation sleeve and winding around the stator module with a metal winding, in which the silicon steel plates can be fixed on the outer periphery of the shaft tube by a tight fit or stuck on the outer periphery of the shaft tube, and the inner periphery of the top insulation sleeve for receiving the shaft tube has an urging part to prevent the bearing from getting loose of coming off by urging against the bearing.

As such, when the stator module of the motor structure is assembled, limited by the axial positional flange 181, the stator module 30 is engaged with the reference plane after the shaft tube is sleeved by the stator module so that the urging part of the top insulation sleeve simultaneously urges against the bearing. The reference plane can definitely define a precise assembling position of the stator module in accordance with a predetermined position for assembling the motor module so as to prevent the bearing from getting loose arising from a too high assembling position of the stator module and also, the deformation and fracture of the urging part arising from a too low assembling position of the stator module and the quality issue that the rotor may fall off.

### BRIEF DESCRIPTION OF THE DRAWINGS

FIG. 1 is a schematic view (I) showing the operational state of a conventional structure;

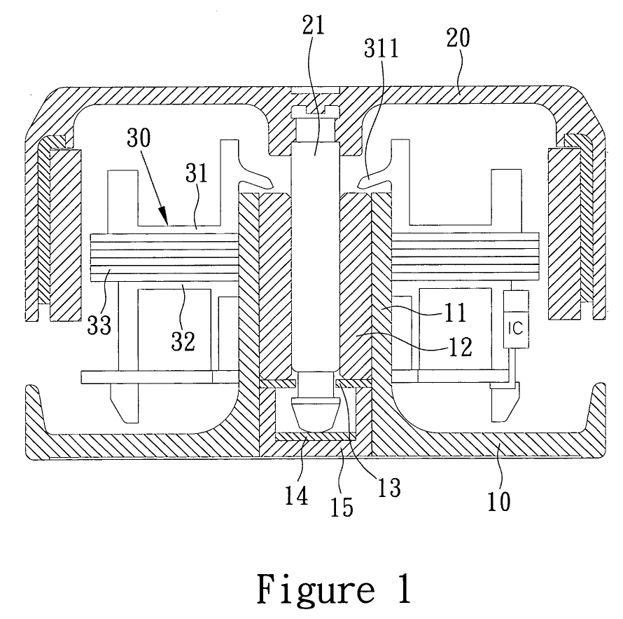

FIG. 2 is a schematic view (II) showing the operational state of a conventional structure;

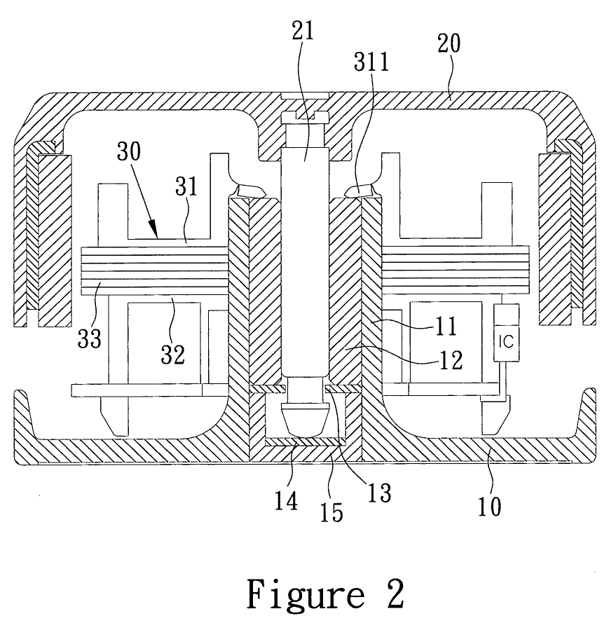

FIG. 3 is a cross-sectional view showing a first preferred embodiment of the present invention;

FIG. 4 is a partly three-dimensional view showing the first preferred embodiment of the present invention; and

FIG. 5 is a cross-sectional view showing a second preferred embodiment of the present invention.

### DETAILED DESCRIPTION OF THE PREFERRED EMBODIMENT

To make the aforementioned objective, features and advantages of the present invention more legible and comprehensible, preferred embodiments of the present invention are specifically presented as follows in conjunction with detailed illustrative description.

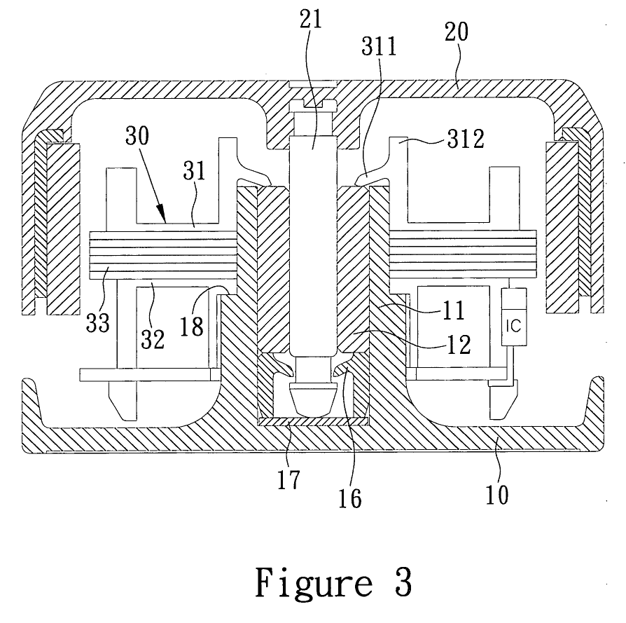

The following preferred embodiments are enumerated for detailed explanation. As shown in FIG. 3, the motor structure of the present invention includes a base 10, a rotor 20 and a stator module 30.

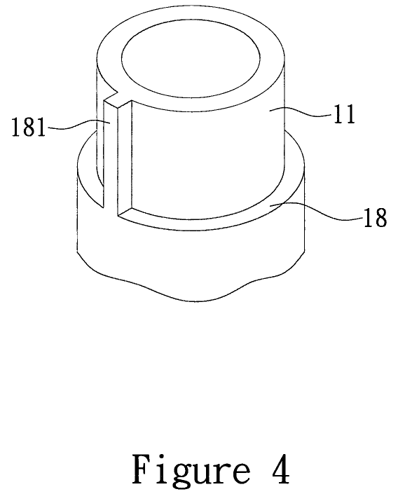

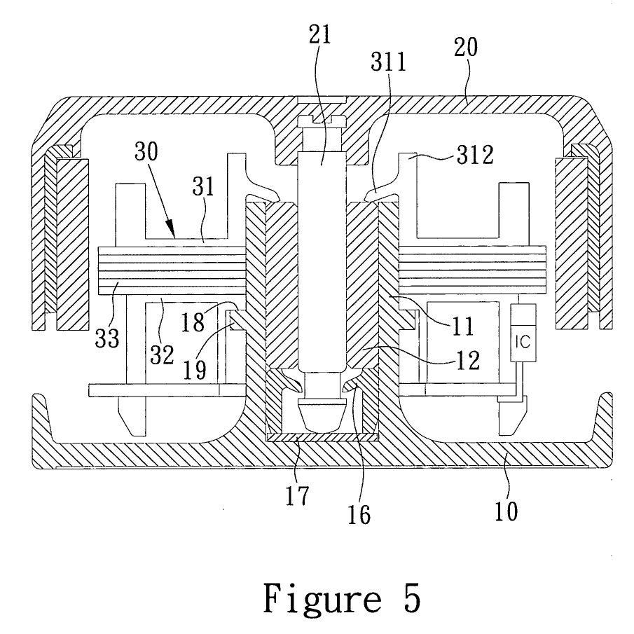

Together with the illustration of FIG. 4, the base 10 has a hollow shaft tube 11 centrally, an axial positional flange 181 is disposed on the outer wall of the shaft tube 11, the bottom portion of the shaft tube 11 is sealed for placing a bearing 12, a snap ring 16 and an abrasive plate 17 therein, and the outer wall of the shaft tube 11 has at least a reference plane 18. The arrangement of the reference plane 18 shown in FIG. 3 can be a pattern with a step mismatch having a smaller outer diameter for the upper half portion of the shaft tube 11 and a larger outer diameter for the lower half portion, so that the reference plane is formed at the portion of the outer wall with step mismatch on the shaft tube 11 with different tube diameters. Also as shown in FIG. 5, a plurality of protruded positioning parts 19 in a block-like or annular form are provided on the outer wall of the shaft tube 11 so that the positioning part 19 can provide a reference plane 18.

The stator module 30 is disposed on the outer wall of the shaft tube 11. Limited by the axial positional flange 181, the stator module 30 is engaged with the reference plane 18. A spindle 21 located centrally in the rotor 20 passes through the bore of the bearing 12 and rotates therein. The rotor 20 and the stator module 30 are integrated correspondingly to form a motor structure.

The stator module 30 is fixed on the outer wall of the shaft tube 11 by a tight-fit means or an adhesive means. The stator module 30 is form by sandwiching silicon steel sheets 33 with a top insulation sleeve 31 and a bottom insulation sleeve 32 and winding metal winding (not shown in FIG. 5) around the place between the top insulation sleeve and the bottom insulation sleeve 31, 32, and using the silicon steel plates to urge against the outer wall the shaft tube 11.

Besides, an annular wall 312 is extended upwardly from the top edge of the inner wall of the top insulation sleeve 31 for receiving the shaft tube 11, and an urging part 311 is disposed on the inner periphery of the annular wall 312 and can be either a plurality of urging pieces or a protruded ring.

Consequently, During the assembly of the stator module of the motor structure, the stator module 30 is exactly engaged with the reference plane 18 after the stator module 30 is sleeved around the shaft tube 11, and the urging part 311 of the top insulation sleeve 31 is urged with the bearing 12 at the same time to prevent the bearing 12 from getting loose or coming off.

Therefore, in contrast to the conventional structure, the present invention has the following advantages:

Convenient and fast assembly of the stator module and the bearing featuring a good positioning effect: The outer periphery on the shaft tube of the motor structure in the present invention has a reference plane. Hence, after the stator module is sleeved around the shaft tube of the motor structure, it can be exactly engaged and positioned on the reference plane, and the urging part of the top insulation sleeve can be simultaneously urged against the bearing. Meanwhile, the reference plane shall be arranged in accordance with a predetermined position for assembling the stator module to definitely define the precise assembling position of the stator module, thereby preventing the assembling position of the stator module from being too high and the bearing from being loose, and also preventing the assembling position of the stator module from being too low and the urging part from being deformed and fractured.

Dustproof: The top insulation sleeve in the stator module of the present invention has an annular wall that is located on the top edge of the inner wall for receiving the shaft tube and is projected upwardly. A protection wall with isolation function is formed around the perimeter of the opening of the shaft tube to effectively block dust from entering the shaft tube.

Oil leakage protection: The bottom portion of the motor structure of the present invention is sealed to form an oil storage space inside the shaft tube, thereby preventing lubricant from being leaked.

In sum, from the above-mentioned characteristics those features not only have a novelty among similar products and a progressiveness but also have an industry utility.

While the invention has been described in terms of what is presently considered to be the most practical and preferred embodiments, it is to be understood that the invention needs not be limited to the circular disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A motor structure, comprising:
a base having a shaft tube centrally, wherein a bottom portion of the shaft tube is sealed for placing a bearing therein, and at least a reference plane is provided on an outer periphery of the shaft tube;
a rotor having a spindle centrally to pass through a bore of the bearing and to rotate therein; and
a stator module disposed on the outer periphery of the shaft tube and positioned on the reference plane, formed by sandwiching a plurality of silicon steel plates with a top insulation sleeve and a bottom insulation sleeve, and winding with a metal winding, and fixed around the outer periphery by a tight fit, wherein the top insulation sleeve is used to receive the shaft tube, and an urging part is disposed on an inner periphery of the top insulation sleeve to urge against the bearing so as to prevent the bearing from getting loose.

2. The motor structure as set forth in claim 1, wherein the reference plane is arranged at a place having a step mismatch on the periphery of the shaft tube so that an upper half portion of the shaft tube has a smaller outer diameter and an lower half portion thereof has a larger outer diameter.

3. The motor structure as set forth in claim 1, wherein the reference plane is provided by an urging part protruded from the outer periphery of the shaft tube.

4. The motor structure as set forth in claim 3, wherein the urging part is a plurality of protruded blocks.

5. The motor structure as set forth in claim 3, wherein the urging part is a protruded ring.

6. The motor structure as set forth in claim 1, wherein an annular wall is extended upwardly from a top edge of an inner periphery of the top insulation sleeve.

7. The motor structure as set forth in claim 1, wherein the urging part is designed to be a plurality of urging pieces.

8. The motor structure as set forth in claim 1, wherein the urging part is a protruded ring.

9. The motor structure as set forth in claim 1, wherein an axial positional flange is disposed on the outer periphery of the shaft tube.

10. A motor structure, comprising:
a base having a shaft tube centrally, wherein a bottom portion of the shaft tube is sealed for placing a bearing therein, and at least a reference plane is provided on an outer periphery of the shaft tube;
a rotor having a spindle centrally to pass through a bore of the bearing and to rotate therein; and
a stator module disposed on the outer periphery of the shaft tube and positioned on the reference plane, formed by sandwiching a plurality of silicon steel plates with a top insulation sleeve and a bottom insulation sleeve, and stuck on the outer periphery of the shaft tube, wherein the top insulation sleeve is used to receive the shaft tube, and an urging part is disposed on an inner periphery of the top insulation sleeve to urge against the bearing so as to prevent the bearing from getting loose.

11. The motor structure as set forth in claim 10, wherein the reference plane is arranged at a place having a step mismatch on the periphery of the shaft tube so that an upper half portion of the shaft tube has a smaller outer diameter and an lower half portion thereof has a larger outer diameter.

12. The motor structure as set forth in claim 10, wherein the reference plane is provided by an urging part protruded from the outer periphery of the shaft tube.

13. The motor structure as set forth in claim 12, wherein the urging part is a plurality of protruded blocks.

14. The motor structure as set forth in claim 12, wherein the urging part is a protruded ring.

15. The motor structure as set forth in claim 10, wherein an annular wall is extended upwardly from a top edge of an inner periphery of the top insulation sleeve.

16. The motor structure as set forth in claim 10, wherein the urging part is designed to be a plurality of urging pieces.

17. The motor structure as set forth in claim 10, wherein the urging part is a protruded ring.

18. The motor structure as set forth in claim 10, wherein an axial positional flange is disposed on the outer periphery of the shaft tube.
